(19) United States
(12) Patent Application Publication
(10) Pub. No.: US 2014/0292268 A1
(43) Pub. Date: Oct. 2, 2014

(54) DEVICE FOR WIRELESS INDUCTIVE ENERGY TRANSFER TO A RECEIVER

(71) Applicant: SIEMENS AKTIENGESELLSCHAFT, MUENCHEN (DE)

(72) Inventors: GERD GRIEPENTROG, GUTENSTETTEN (DE); THOMAS KOMMA, OTTOBRUNN (DE); MONIKA POEBL, MUENCHEN (DE)

(73) Assignee: SIEMENS AKTIENGESELLSCHAFT, MUENCHEN (DE)

(21) Appl. No.: 14/227,066

(22) Filed: Mar. 27, 2014

(30) Foreign Application Priority Data
Mar. 27, 2013 (DE) 102013205481.5

(51) Int. Cl. B60L 11/18

(52) U.S. Cl. CPC B60L 11/182; B60L 11/1811
USPC 320/108

(57) ABSTRACT

A device for wireless inductive energy transfer to a receiver, in particular an energy storage device of an electrically powered vehicle, includes at least one transformer coil and a compensation capacitor array. During the operation of the device at a resonance frequency, the compensation capacitor array compensates for an inductive voltage drop across the transformer coil. The compensation capacitor array has a plurality of capacitors, at least some of which are arranged on at least one printed-circuit board in the form of at least one winding and are electrically connected to one another in series for the purpose of embodying the transformer coil.

### CROSS-REFERENCE TO RELATED APPLICATION

This application claims the priority, under 35 U.S.C. §119, of German patent application DE 10 2013 205 481.5, filed Mar. 27, 2013; the prior application is herewith incorporated by reference in its entirety.

### BACKGROUND OF THE INVENTION

### Field of the Invention

The invention relates to a device for wireless inductive energy transfer to a receiver, in particular an energy storage device of an electrically powered vehicle. The device comprises at least one transformer coil and a compensation capacitor array. During operation of the device at a resonance frequency, the compensation capacitor array compensates for an inductive voltage drop across the transformer coil.

The device for wireless inductive energy transfer constitutes a primary side of an energy transfer means. The receiver represents a secondary side of the energy transfer means. The transmission path formed between the transformer coils on the primary side and the secondary side has an air gap whose length has an influence on the magnitude of the leakage inductances on the primary side and the secondary side.

The invention is described herein below with reference to an energy transfer means for inductively supplying power to electric vehicles. This is not to be considered as limiting, however. The device for wireless inductive energy transfer could also be used in other applications, in particular in such applications in which there is a requirement for high-power transmission capacities.

If the device is employed for charging an energy storage device of an electrically powered vehicle, then the air gap can be 10 cm or greater. This is due to the fact that the transformer coil of the device (i.e. of the primary side) is preferably integrated in the floor of a vehicle parking space, while the transformer coil of the secondary side of the vehicle is arranged, for example, in a floor-side car body component. If the vehicle is driven into a predetermined position onto the vehicle parking space, the transformer coils of the primary side and the secondary side come to be positioned one above the other, thereby enabling a magnetic coupling.

In such a configuration the magnitude of the primary-side and secondary-side leakage inductance is equal to or even greater than the main inductance of the energy transfer means. When current flows, a correspondingly large inductive voltage drop is produced across the leakage inductance of the primary side, which leads to the absence of a corresponding voltage at the energy-consuming load that is to be supplied on the secondary side. Charging the energy storage device of the vehicle is consequently associated with high losses. This effect can be compensated for by means of a higher input voltage of the primary-side voltage source or by means of what is termed a compensation capacitor array in the primary side of the energy transfer means. The compensation capacitor array compensates for the inductive voltage drop at the resonance frequency.

Implementing a compensation capacitor array by way of a single capacitor is not possible in practice due to the necessary size, which cannot be provided at acceptable cost. The compensation capacitor array is therefore realized on the basis of what is known as a capacitor bank, in which separate capacitors are connected in parallel with the windings of the primary-side transformer coil and/or in series with said windings. The individual capacitors are combined in the desired interconnection arrangement on a common printed-circuit board and connected to the coil ends of the transformer coil. This component requires a considerable amount of space in addition to the primary-side transformer coil and it is very heavy. Furthermore, a significant voltage drops across the capacitor bank, as a result of which there is a strong heat buildup in the capacitor bank and corresponding losses occur.

### SUMMARY OF THE INVENTION

It is accordingly an object of the invention to provide a device which overcomes the above-mentioned disadvantages of the heretofore-known devices and methods of this general type and which provides for a device for wireless inductive energy transfer to a receiver which represents an improvement in structural and/or functional terms. It is in particular an object of the present invention to describe a device of improved construction and/or functionality for wireless inductive energy transfer to an energy storage device of an electrically powered vehicle.

With the foregoing and other objects in view there is provided, in accordance with the invention, a device for wireless inductive energy transfer to a receiver, in particular to an energy storage device of an electrically powered vehicle. The device comprises:

at least one printed circuit board;

a compensation capacitor array having a plurality of capacitors mounted on the at least one printed-circuit board in the form of at least one winding and electrically connected to one another in series for forming a transformer coil;

the compensation capacitor array being configured, during an operation of the device at a resonance frequency, to compensate for an inductive voltage drop across the transformer coil.

In other words, there is described a device for wireless inductive energy transfer to a receiver, in particular an energy storage device of an electrically powered vehicle, which device comprises at least one transformer coil as well as a compensation capacitor array. During operation of the device at a resonance frequency the compensation capacitor array compensates for an inductive voltage drop across the transformer coil. The compensation capacitor array comprises a plurality of capacitors, at least some of which are arranged on at least one printed-circuit board in the form of at least one winding and which are electrically connected to one another in series for the purpose of embodying the transformer coil.

The proposed device has the advantage that there is no separation of parasitic leakage inductance and compensation capacitance. Because the capacitors of the compensation capacitor array are already part of the winding(s) of the transformer coil, the ends of the transformer coil are subject to a substantially smaller voltage load. This enables the insulation of the coil ends to be realized in a simpler and more economical manner. A further advantage consists in the compensation capacitor array now no longer having to be provided as a separate capacitor bank in addition to the transformer coil, as a result of which the device has a smaller design footprint compared to a conventional device.

If, according to one embodiment, all of the capacitors of the compensation capacitor array are arranged on the printed-circuit board in the form of the at least one winding, then the capacitor bank required in the prior art can be omitted altogether. This enables the device to be provided in a particularly space-saving implementation.

If only some of the total number of capacitors of the compensation capacitor array are arranged on the printed-circuit board in the form of the at least one winding, then the remainder of the capacitors can be realized as a capacitor bank. In contrast to the prior art, such a capacitor bank can be implemented in a substantially smaller design, since only some of the capacitors of the compensation capacitor array need to be provided in the capacitor bank. Compared to the device known from the prior art, a lower voltage drops across the smaller capacitor bank, resulting in lower losses. The reduced voltage drop across the smaller capacitor bank comes about because some of the capacitors of the compensation capacitor array are already arranged on the printed-circuit board in the form of the at least one winding and consequently a portion of the voltage already drops across said capacitors.

An individual winding of the transformer coil can be embodied by means of conductor track sections electrically connecting two adjacent capacitors in each case. In contrast to the prior art it is no longer necessary to produce the winding(s) using an insulated stranded wire which must be inserted manually e.g. into a spiral-shaped groove of a printed-circuit board. This enables the device to be produced in a more simple and economical way through recourse to automated production methods.

Viewed from above, the at least one winding can be embodied in sections as round, oval or rectangular. Generally, the winding can have any desired shape as long as the inductive transfer of energy to the receiver is ensured. If the transformer coil comprises a plurality of windings, then the dimensioning of the pitch of the windings is determined on the basis of the space required for the capacitors.

The ends of the transformer coil can be arranged in overlapping fashion on the printed-circuit board in order to form a capacitor which is connected in parallel with the transformer coil and by means of which a magnetization current can be compensated. By means of the overlapping arrangement of the ends of the transformer coil on the printed-circuit board, a parasitic capacitor is embodied which because of its parallel connection to the winding or windings of the transformer coil can at least partially compensate for the magnetization current during the operation of the device. The electrical characteristics can be adjusted by means of the overlapping surface and/or the thickness of the printed-circuit board. A further, discrete capacitor can optionally be connected to the coil ends of the transformer coil. Compared to a conventional device, however, said discrete capacitor can then be implemented in a substantially smaller embodiment, as a result of which it is possible to provide the device with a small volume.

The capacitors of the compensation capacitor array can be SMD components. This enables the capacitors which are arranged on at least one printed-circuit board in the form of at least one winding to be electrically connected to the conductor track sections by means of a common soldering process (e.g. wave soldering). This results in simple and cost-effective production by virtue of its being automated.

In one embodiment a plurality of windings can be arranged in one plane on the printed-circuit board. With this embodiment, the device can be provided with a minimum overall construction height. The overall construction height is essentially determined by the thickness of the printed-circuit board and the height of the capacitors.

In an alternative or additional embodiment a plurality of windings can be arranged in a plurality of planes on a plurality of printed-circuit boards. With this embodiment, the number of windings on each printed-circuit board can be selectively chosen. This means an equal number of windings can be embodied on each of the plurality of printed-circuit boards. The number of windings on the plurality of printed-circuit boards can also be different.

In order to strengthen the magnetic coupling to the transformer coil of the receiver, the transformer coil of the proposed device can include a core. The core can be formed from a ferrite, for example.

The core can be arranged in an opening of the at least one printed-circuit board. The core is then wrapped around by the winding or windings of the transformer coil of the printed-circuit board. Alternatively, the core can be arranged as a plate or film on a reverse side of the at least one printed-circuit board. In this case it is not necessary to provide an opening in the at least one printed-circuit board.

Other features which are considered as characteristic for the invention are set forth in the appended claims.

Although the invention is illustrated and described herein as embodied in a device for wireless inductive energy transfer to a receiver, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an electrical equivalent circuit diagram illustrating a prior art inductive transfer path having series compensation of leakage inductances;

FIG. 2 is a schematic representation of a device according to the invention in which a transformer coil is formed by way of example from a single winding that is embodied on a printed-circuit board;

FIG. 3 is a side view of a device according to the invention which comprises a single printed-circuit board for the purpose of embodying the transformer coil; and

FIG. 4 is a side view of an alternative exemplary embodiment of a device according to the invention in which a plurality of printed-circuit boards arranged vertically above one another are provided for the purpose of embodying the transformer coil.

### DETAILED DESCRIPTION OF THE INVENTION

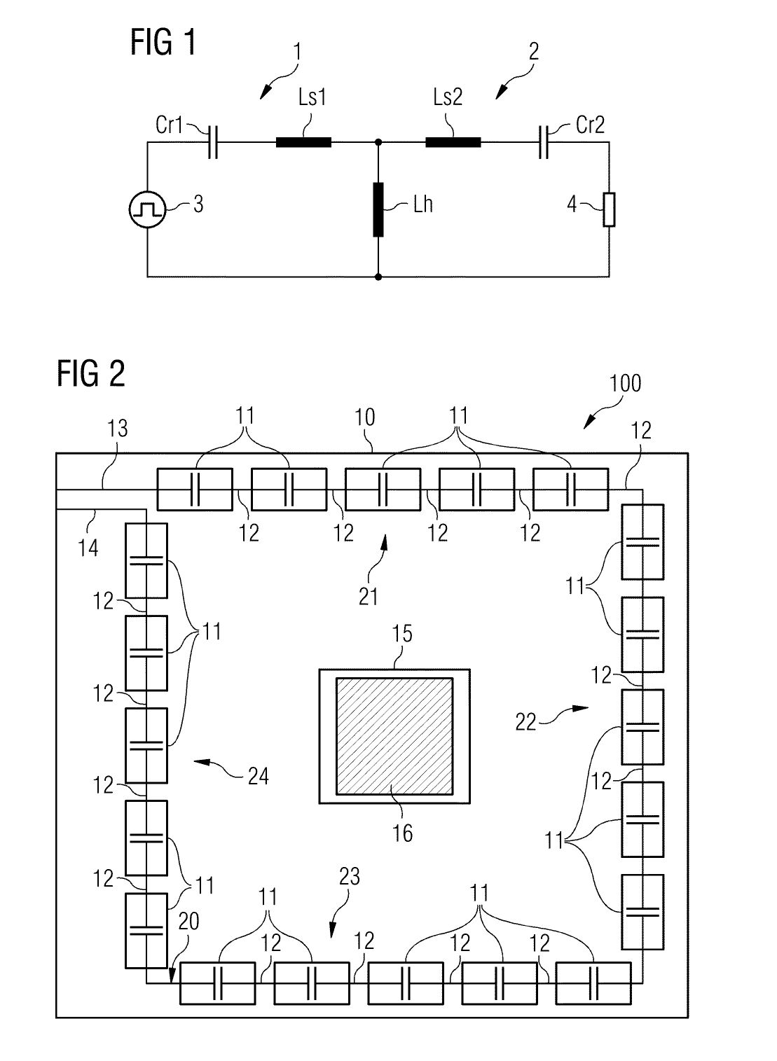

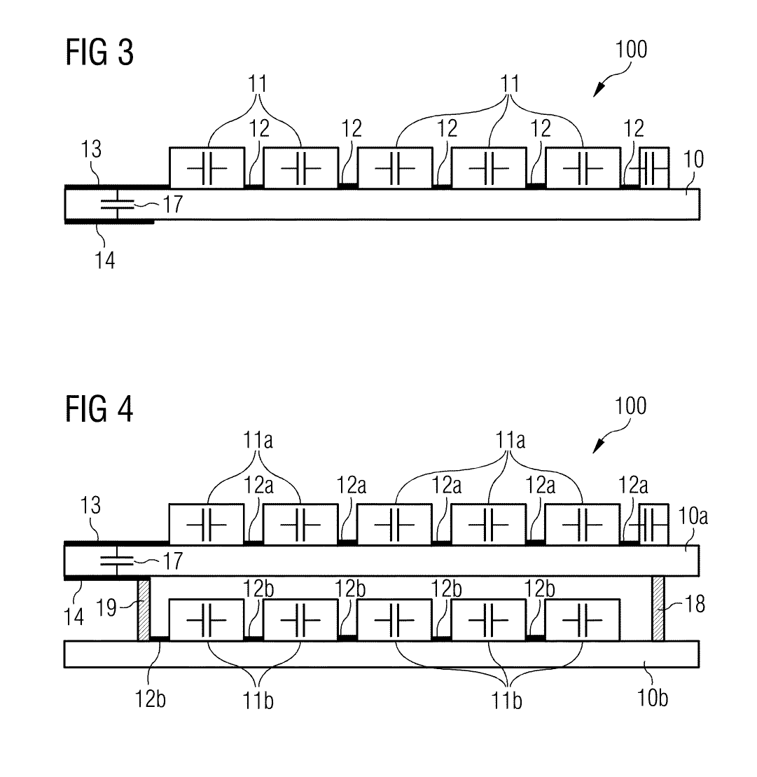

Referring now to the figures of the drawing in detail and first, particularly, to FIG. 1 thereof, there is shown an electrical equivalent circuit diagram of an inductive transfer path with series compensation of leakage inductances, as it is known from the prior art. The transfer path is formed from a primary-side transformer coil and a secondary-side transformer coil. The primary side is identified by “1” in FIG. 1, the secondary side by “2”. The primary side 1 constitutes a device for wireless inductive energy transfer to a receiver.

The primary side 1 comprises an energy source 3 which is connected via a compensation capacitance array to a primary-side transformer coil. In FIG. 1, the compensation capacitance array is represented by the capacitance Cr1, and the primary-side transformer coil is represented by a primary-side leakage inductance Ls1 as well as a main inductance Lh. In the electrical equivalent circuit diagram shown in FIG. 1, the leakage inductance Ls1, the main inductance Lh and the capacitance Cr1 are connected to one another in series.

The secondary side 2 comprises an energy-consuming load 4, for instance an energy storage device of an electrically powered vehicle which is connected via a compensation capacitance array to a secondary-side transformer coil. In FIG. 1, the compensation capacitance array is represented by the capacitance Cr2, and the secondary-side transformer coil by a secondary-side leakage inductance Ls2 as well as the main inductance Lh. In the electrical equivalent circuit diagram shown in FIG. 1, the leakage inductance Ls2, the main inductance Lh and the capacitance Cr2 are connected to one another in series.

The transmission path formed between the transformer coils on the primary side 1 and the secondary side 2 has an air gap which has an influence on the magnitude of the leakage inductances Ls1, Ls2 on the primary side 1 and the secondary side 2. It is assumed hereinafter by way of example that the energy storage device of an electric vehicle is to be charged by way of the wireless inductive energy transfer. In this case the air gap between the primary-side transformer coil and the secondary-side transformer coil can, as has already been described in the introduction, be 10 cm (4 in) or greater. This is a result of the transformer coil of the primary side 1 preferably being integrated in the floor of a vehicle parking space, while the transformer coil of the secondary side 2 of the vehicle is arranged e.g. in a floor-side car body component. If the vehicle is driven into a predetermined position onto the vehicle parking space, the transformer coils of the primary side and the secondary side come to be positioned one above the other, thereby making the magnetic coupling possible.

In that configuration the magnitude of the primary-side and secondary-side leakage inductances Ls1, Ls2 is equal to or even greater than the main inductance Lh of the energy transfer means. When current flows, a correspondingly large inductive voltage drop, which can amount to a multiple of the voltage provided by the energy source, is produced across the leakage inductance Ls1 of the primary side. During operation of the transfer means at resonance frequency, the voltage dropping across the leakage inductance Ls1 is compensated for in particular by way of the compensation capacitor array, i.e. the capacitance Cr1, in the primary side 1 of the energy transfer means.

Instead of resorting to what is common practice in the prior art, which is to say implementing the compensation capacitor array as a capacitor bank in which a multiplicity of individual capacitors are arranged concentrated in close spatial relationship to one another on a printed-circuit board that is separate from the transformer coil, the plurality of capacitors 11 are, according to the invention, arranged on a printed-circuit board 10 in the form of at least one winding 20. For the purpose of embodying the winding or windings 20 and hence the transformer coil, the capacitors are electrically interconnected serially via conductor track sections 12. This is illustrated by way of example in FIG. 2, which shows a schematic view from above onto a device 100 for wireless inductive energy transfer according to the invention.

Here, FIG. 2 shows, merely by way of example, a single winding 20 which is formed from four straight winding segments 21, 22, 23, 24. Each winding segment 21, 22, 23, 24 comprises, merely by way of example, five individual capacitors 11, two adjacent capacitors 11 in each case being electrically connected to one another in series via conductor track sections 12. For the sake of simplicity not all of the conductor track sections have been labeled with a reference sign. Contrary to the arrangement in the manner of a rectangle or square, the winding segments 21, 22, 23, 24 could also be embodied in a curved shape, such that in its totality the winding 20 is embodied as substantially oval or round.

The conductor track sections 12 are part of a conductor track structure applied to the printed-circuit board 10 before the capacitors 11 are mounted. The capacitors 11 are SMD (Surface Mounted Device) components which can be electrically and mechanically connected to the conductor track structure and hence to the conductor track sections by means of a common soldering process. The winding 20 is therefore formed by means of conductor track sections 12 and capacitors 11 arranged in alternation on the printed-circuit board 10.

Embodied in the center of the winding 20 in the printed-circuit board 10 is an optional cutout or opening 15 through which a core 16, e.g. made of a ferrite, is inserted. The magnetic coupling to the secondary-side transformer coil (not shown) can be improved by this means. Alternatively to the embodiment shown, the core 16 could also be applied as a plate or film to the reverse side of the printed-circuit board 10 (i.e. to the main side of the printed-circuit board 10 facing away from the capacitors 11).

In an alternative embodiment the transformer coil could have a plurality of windings 20 implemented on the printed-circuit board 10. For that purpose additional winding segments could be run internally in the manner of a spiral around the optional core 16 shown in FIG. 2.

Alternatively or in addition, a plurality of the devices shown in FIG. 2 can be stacked vertically one on top of the other, in which case the winding(s) embodied on the plurality of printed-circuit boards 10a, 10b will then be electrically connected to one another via corresponding electrical connecting elements 18, 19. This is represented schematically in a side view in FIG. 4. By this means it is possible to provide a helical winding of the transformer coil.

In the example shown in FIG. 2, ends 13, 14 of the winding 20 (or generally: of the transformer coil) come to be positioned adjacent to each other. The coil ends 13, 14 can be arranged on the main side of the printed-circuit board 10 on which the capacitors 11 are arranged. The coil ends 13, 14 can also be arranged on different main sides of the printed-circuit board 10. Owing to the proposed interconnection of the capacitors, a substantially lower voltage drops at the coil ends compared to a conventional device.

If the coil ends are arranged on the opposite main surfaces of the printed-circuit board 10 and opposite each other, as is shown by way of example in FIG. 2, then by this means a parasitic capacitor 17 is produced which is connected in parallel with the winding 20 (or in the case of a plurality of windings: the transformer coil). A magnetization current flowing through the winding 20 (or, as the case may be, the transformer coil) can be at least partially compensated for by means of the parasitic capacitor 17. The end 14 on the opposite main side of the printed-circuit board to the capacitors can be embodied by means of a plated-through hole.

A further, discrete capacitor can optionally be connected to the coil ends 13, 14 of the winding 20 or, as the case may be, of the transformer coil. Compared to a conventional device, however, said discrete capacitor can then be realized in a substantially smaller embodiment, as a result of which it is possible to provide the device 100 with a small volume.

It is beneficial also in the case of a device 100 which is formed from a plurality of printed-circuit boards 10a, 10b arranged vertically one above the other, each having capacitors 11a and 11b, respectively, and conductor track sections 12a and 12b, respectively, arranged thereon in winding form, if the ends 13, 14 of the transformer coil are arranged at least partially overlapping on opposite sides of one of the printed-circuit boards 13.

Only two printed-circuit boards 10a, 10b are depicted in the exemplary embodiment shown in FIG. 4, wherein an electrical connection of the windings realized on the printed-circuit boards 10a, 10b is established by way of the already mentioned electrical connecting elements. Basically, the number of printed-circuit boards arranged vertically one above the other can be chosen arbitrarily.

The number of printed-circuit boards (a single board or a plurality thereof) as well as the number of capacitors provided in total on the printed-circuit board or boards are dimensioned according to the electrical characteristics of the capacitors as well as by the electrical characteristics that are desired to be achieved in respect of the device.

An advantage of the approach described consists in there being no separation between parasitic leakage inductance and the capacitors used for the compensation.

The formerly necessary printed-circuit board for the capacitor bank can be dispensed with, as a result of which the device can be provided with a reduced volume.

The voltage loading of the capacitors distributed over the winding is very small in comparison with a conventional capacitor bank.

There exists the possibility to exploit the requisite capacitor size for forming the winding by appropriate choice of the number of capacitors distributed over the winding.

The device described can be used in particular as a so-called floor element for inductively supplying power to electric vehicles.

1. A device for wireless inductive energy transfer to a receiver, comprising:
at least one printed circuit board;
a compensation capacitor array having a plurality of capacitors mounted on said at least one printed-circuit board in the form of at least one winding and electrically connected to one another in series for forming a transformer coil, said compensation capacitor array being configured, during an operation of the device at a resonance frequency, to compensate for an inductive voltage drop across said transformer coil.

2. The device according to claim 1, wherein the receiver is an energy storage device of an electrically powered vehicle.

3. The device according to claim 1, wherein all of said capacitors of said compensation capacitor array are mounted on said at least one printed-circuit board forming said at least one winding.

4. The device according to claim 1, wherein said winding is formed by conductor track sections electrically connecting mutually adjacent capacitors in each case.

5. The device according to claim 1, wherein, in a plan view, said winding has a shape selected from the group consisting of round, oval, and rectangular.

6. The device according to claim 1, wherein said transformer coil has ends overlapping one another on said printed-circuit board for forming a capacitor that is connected in parallel with said transformer coil and by way of which a magnetization current is compensated.

7. The device according to claim 1, wherein said capacitors are SMD components.

8. The device according to claim 1, wherein said at least one winding is one of a plurality of windings disposed in one plane on said printed-circuit board.

9. The device according to claim 1, wherein said at least one winding is one of a plurality of windings disposed in a plurality of planes on a plurality of printed-circuit boards.

10. The device according to claim 1, wherein said transformer coil includes a core.

11. The device according to claim 10, wherein said core is disposed in an opening of said at least one printed-circuit board.

12. The device according to claim 10, wherein said core is disposed on a side of said at least one printed-circuit board opposite from said compensation capacitor array.

13. The device according to claim 12, wherein said core is a plate or a film disposed on the reverse side of said at least one printed circuit board.
